(19) United States
(12) Patent Application Publication
(10) Pub. No.: US 2006/0023904 A1
(43) Pub. Date: Feb. 2, 2006

(54) Hearing aid

(75) Inventor: Eghart Fischer, Schwabach (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: Siemens Audiologische Technik GmbH

(21) Appl. No.: 11/194,926

(22) Filed: Aug. 2, 2005

(30) Foreign Application Priority Data
Aug. 2, 2004 (DE) 10 2004 037 377.9

(51) Int. Cl. H04R 25/00

(52) U.S. Cl. 381/312; 381/314

(57) ABSTRACT

In a hearing aid the emission of a voice signal to announce the current time of day is to be output in a simple and cost-effective manner. In addition, a proposal is made to only save the voice signal for the current time of day in the hearing aid and to constantly update this voice signal by means of an external transmitter, preferably a remote controller. In this way, less memory space is thus required in the hearing aid for the time announcement.

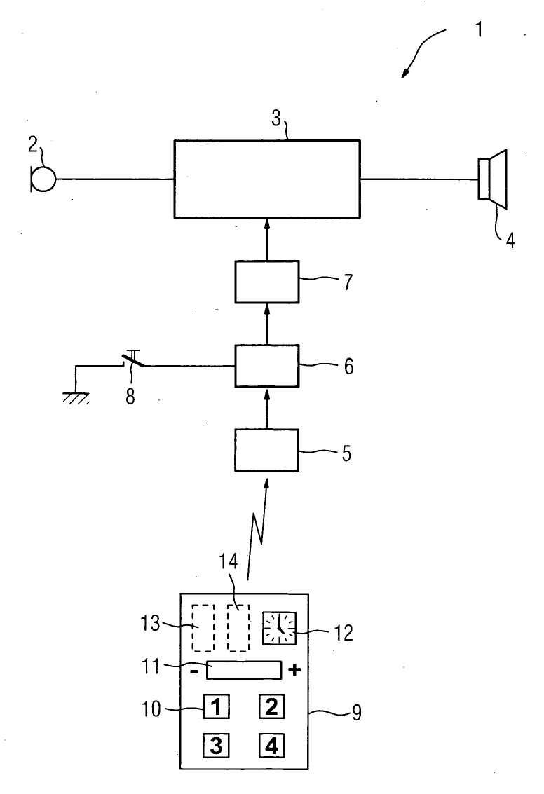

### CROSS REFERENCE TO RELATED APPLICATIONS

This application claims priority to the German application No. 10 2004 037 377.9, filed Aug. 2, 2004 which is incorporated by reference herein in its entirety.

### FIELD OF INVENTION

The invention relates to a hearing aid system with at least one hearing aid comprising an input converter for recording an input signal and converting said signal into an electrical input signal, a signal processing unit for processing and frequency-dependent amplification of the input signal, and an output converter for generating an output signal which can be perceived by a user as an acoustic signal, in which the hearing aid system further comprises an external transmitter to transfer data to the hearing aid and in which an announcement of the current time of day can be output by the hearing aid in conjunction with the external transmitter.

### BACKGROUND OF INVENTION

In particular, the elderly hearing impaired are often also visually impaired and have difficulties in reading the time and date on small wrist watches or clocks located at a distance, e.g. in train stations etc.

DE32 05 686 C2 discloses a hearing aid in which a spoken time announcement can be effected via an electromagnetic converter. In this way, a time function can be implemented in a microcomputer in a simple manner.

DE 35 45 088 A1 discloses an alarm facility which is built into an in-the-ear hearing aid in one embodiment. A time announcement, an appointment notification or any other notification can also be associated with an alarm.

U.S. Pat. No. 5,721,783 discloses a hearing aid system with a processor device which can be worn on the body and a receiver device which can be worn on the head. The external processor device comprises a clock as well as means for generating a voice a announcement for the current time of the day. For this purpose, a corresponding voice signal is transmitted to the receiver device in electric or electromagnetic form and is emitted therefrom as an acoustic voice signal. This also allows the signal transmission to take place in a wireless manner.

### SUMMARY OF INVENTION

A clock and a memory are needed to store all the words needed for the different time announcements in order to be able to provide a time announcement in a hearing aid which can be worn on the head without connection to an external device. This gives rise to problems particularly in terms of memory space and energy in a hearing aid which can be worn in the auditory canal, since the possible chip surface and the loading capacity of the applied voltage source are both significantly restricted. Aside from that, hearing devices which can be worn outside the auditory canal on the head should be as small and as inconspicuous as possible. The integration of all components required for a time announcement of this type in a hearing aid which can be worn on the head is thus only possible with a considerable technical outlay and expense. The announcement of the time in hours and minutes alone requires 60 words to be stored for the numbers from 0 to 59. The memory needed for this is not provided in today's hearing aids.

One alternative for storing the necessary voice signals in the hearing aid would be the transmission of a signal from an external transmitter to the hearing aid, said signal containing the data required to emit the acoustic voice signals. This gives rise to the problem that the data transmission for the voice output must take place at least approximately in real time, since a lengthy wait for a time request would not be accepted by a user. A high data transmission rate between the external transmitter and the hearing aid is certainly necessary for this purpose. This problem is also only to be solved in today's hearing aids with relatively high outlay and is therefore expensive.

An object of the present invention is thus to allow a time a nnouncement in hearing aids which can be implemented in a simple and cost-effective manner.

In a hearing aid system with at least one hearing aid comprising an input converter for recording an input signal and converting said signal into an electrical input signal, a signal processing unit for processing and frequency-dependent amplification of the electrical input signal and an output converter for generating an output signal which can be perceived by the user as an acoustic signal, in which the hearing aid system further comprises an external transmitter for the wireless transmission of data to the hearing aid and in which an announcement of the current time of day can be given out by the hearing aid in conjunction with the external transmitter, this object is achieved in that only voice signals for a small part of the voice signals which are required for all the time announcements which can be given out by the hearing aid system are stored in the hearing aid, in which the voice signal is stored in particular for the current time announcement and can be given out on request and in which said voice signal can be continuously updated by a signal transmitted from the external transmitter to the hearing aid.

In a hearing aid, an input signal is recorded by means of an input converter and transferred into an electrical input signal. Typically at least one microphone serves as an input converter, said microphone recording an acoustic input signal. Modern hearing aids frequently comprise a microphone system with several microphones in order to achieve a reception dependent on the incident direction of the acoustic signals, a directivity pattern. Nevertheless, the input converters can also comprise a telephone coil or an antenna for recording electromagnetic input signals. The input signals converted by the input converter into electrical input signals are supplied to a signal processing unit for further processing and amplification purposes. In order to balance out the individual hearing loss of a hearing aid wearer, the further processing and amplification generally take place as a function of the signal frequency. The signal processing unit gives out an electrical output signal which is fed to the ear of the hearing aid wearer by means of an output converter, said ear perceiving the output signal as an acoustic signal. Receivers are typically used as output converters, said receivers generating an acoustic output signal. Nevertheless, output converters for generating mechanical vibrations are known which directly cause specific parts of the ear to vibrate, such as the auditory ossicles for example. Furthermore, output converters are known which directly stimulate nerve cells in the ear.

The invention is advantageous in that generally only the words needed for the current time of day are stored in the hearing aid. On request, the acoustic voice signal is formed from these words for the current time announcement. In the hearing aid, a maximum of two words must be stored for the hours and minutes as well as the words ‘hours’ and ‘minutes’. A possible acoustic voice signal which can be emitted by the hearing aid is ‘14 hours 25 minutes’. The subsequent time announcement would then say ‘14 hours 26 minutes’. This announcement requires the transmission of a voice signal for the word ‘26’ to the hearing aid. Since with the hearing aid system according to the invention the voice signal stored in the hearing aid is constantly updated for the current time announcement, one minute of time remains for this updating. During said time which is available, it is possible to update the voice signal required for the voice output in the hearing aid, even if only on e transmission channel with a relatively low data transmission rate is available for this purpose. The transmission components are already sufficient for this purpose, said transmission components hitherto being used in a hearing aid system with at least one hearing aid and a remote controller for the wireless operation of the hearing aid. The invention can thus be implemented with relatively simple means for signal transmission which are already used nowadays, as well as with a small memory requirement in the hearing aid. Nevertheless, the user is immediately able to hear the current time announcement at all times.

The voice signals which are transmitted by remote control to the hearing aid and stored in the hearing aid can preferably be transmitted and stored in digitized form. The voice signals are advantageously compressed for transmission and storage purposes. The method known for example as ‘MP3’ can be used for compression purposes. The compression allows a further reduction in the data transmission rate between the remote controller and hearing aid as well as a further reduction in the storage space required in the hearing aid.

The external transmitter of the hearing aid system is prefer ably designed as a remote controller for the hearing aid, in which the functionality required for the time announcement is also integrated. Another variant provides for the external transmitter to be integrated into a wrist watch with the additional functionality needed for the time announcement. A combination of the two last mentioned possibilities is also taken into consideration, in other words, a remote controller designed in the form of a wrist watch for the hearing aid with the corresponding additional functionality.

The invention can be further developed such that in addition to the time of the day, the current day of the week or the current date can be transmitted by means of corresponding voice signals in a similar manner from the external transmitter to the hearing aid and can be stored and/or retrieved there. If there is only a relatively small amount of memory in the hearing aid, a time and data announcement could then be retrieved for example ‘Thursday, 24^{th} Jun. 2004, 14 hours 25 minutes.’

### DETAILED DESCRIPTION OF INVENTION

The invention is described below with reference to an exemplary embodiment.

In this way the figure shows a hearing aid system 1, 9 with a hearing aid 1 in an extremely simplified block diagram and a remote controller 9. A microphone 2 serves as an input converter of the hearing aid 1 to record an acoustic input signal and convert said signal into an electrical input signal. The electrical input signal is further processed in a signal processing unit 2 and amplified as a function of the signal frequency. The processed signal is then converted back into an acoustic signal by means of a receiver 4 and fed to the ear of the user. The remote controller 9 enables the hearing aid 1 to be controlled by the user. By activating one of the program selection keys 10 labeled and serially numbered in each instance with ‘1’ to ‘4’, a program selection and thus an adaptation of the signal processing in the hearing aid to different auditory environments is possible. Furthermore, the sound level can be adjusted by means of a rocker switch 11. The remote controller 9 comprises a transmitter device (not shown) for the wireless transmission of control data from the remote controller 9 to the hearing aid 1. The hearing aid 1 correspondingly comprises a receive device 5 for receiving the transmitted data. The receive device has a receive coil or an antenna in order to receive the wirelessly transmitted data.

According to the invention with the hearing aid system 1, 9 of the exemplary embodiment, voice signals should also be transmitted in addition to the known control signals, it being possible for the hearing aid 1 to generate a voice announcement from said voice signals. A clock is naturally needed for a time announcement. The remote controller 9 thus advantageously comprises a time of day facility 13, which preferably also comprises a calendar function for the current day of the week and the current date. In a particularly advantageous development, the time of day facility 13 also comprises a receiver for receiving a radio controlled clock signal, e.g. of the DCF 77 time signal which can be received in Germany. This guarantees that the current time of day is always available in the remote controller 9 to the last second and the changeover between winter and summer time is also automatically taken into account. The remote controller 9 according to the invention further comprises a memory 14 for storing the necessary voice signals for a voice output of the numbers 0 to 59, the days of the week, the months and the years 2004 to 2025.

According to the invention, the remote controller 9 sends a voice signal at the beginning of each new minute during the operating state, behind which is concealed the numeric value of the current minute incremented by 1. If a change in the current hour, the current weekday, the current month or the current year is associated with the change to the current minute, voice signals relating thereto are also transmitted, behind which are concealed the current hour, the current day of the week, the current month or the current year. The relevant voice signals are present in the memory 14 in digital and preferably compressed form. In the immediate vicinity of the remote controller 9, the transmitted data can be received by the receive device 5 of the hearing aid 1. The received data (voice signals) for the current year, the current month, the current week day, the current hour and the current minute are finally deposited in a memory 6 of the hearing aid 1. By actuating a spring-loaded switch 8, the stored data is decompressed in a decoder 7, decoded and fed to the ear of the user via the signal processing unit 3 and the receiver 4 as an acoustic voice signal adapted to the hearing loss of a user. At the touch of a button, the user thus immediately hears the current time and the current date precise to the minute. In addition to the spring-loaded switch 8 of the hearing aid 1, the remote controller 9 also comprises a time announcement key 12, so that a read-out of the current content of the memory 6 and thus a current time announcement can be triggered by means of a corresponding control signal in addition to the activation of the spring-loaded switch 8 and by activating the time announcement key 12 on the remote controller 9.

The hearing aid 1 preferably also comprises a controller (not shown) which registers if no valid voice signal was transmitted to the memory 6 within the last minute, thereby resulting in no voice signal being present therefore for the current time. Advantageously the activation of the spring-loaded switch 8 or the time announcement key 12 does not then cause the voice signal deposited in the memory 12 to be output, but instead another signal, for example a short beeping tone, which notifies the user of the absence of a current time announcement.

1-8. (canceled)

9. A hearing aid system, comprising:
a hearing aid unit, comprising:
an input converter for acquiring an input signal and converting the input signal into an electrical input signal;
a signal processing unit for processing and frequency-dependent amplifying the electrical input signal;
an output converter for generating an output signal perceivable by a user of the hearing aid as an acoustic signal; and
an external transmitter for the wirelessly transmitting data to the hearing aid unit, wherein
the hearing aid unit is configured to output a current time message as a speech signal using the external transmitter,
the hearing aid includes a memory unit having at least one stored speech signals for outputting the current time message, the at least one stored speech signal not sufficient for outputting every possible time message corresponding to every possible point in time during a day, and
the at least one stored speech signal is continuously updated to correspond to the current time using an update signal transmitted to the hearing aid unit by the external transmitter, such that the updated stored speech signal can be output to the user as the current time message using the output converter.

10. The hearing aid system according to claim 9, wherein the stored speech signal is updated every minute.

11. The hearing aid system according to claim 9, wherein the update signal includes an update speech signal storable in the memory unit.

12. The hearing aid system according to claim 9, wherein the stored and updated stored speech signals are preprocessed signals generated by a signal compression algorithm.

13. The hearing aid system according to claim 12, wherein the stored and updated stored speech signals are stored as MP3 files.

14. The hearing aid system according to claim 9, wherein the external transmitter is a remote controller for the controlling the hearing aid unit.

15. The hearing aid system according to claim 9, wherein the external transmitter is a wrist watch having common watch functionality and configured to control the hearing aid unit.

16. The hearing aid system according to claim 9, wherein the current time message includes the current day of the week.

17. The hearing aid system according to claim 9, wherein the current time message includes the current date.
